(19) United States
(12) Patent Application Publication
(10) Pub. No.: US 2010/0012720 A1
(43) Pub. Date: Jan. 21, 2010

(54) SYSTEM AND METHODS TO SELECT AUTHORIZED VENDORS FOR PREPAID DEBIT CARD/CREDIT CARD

(76) Inventors: Jon Baker-Dean, Gaithersburg, MD (US); Vincent Hillenmeyer, Great Falls, VA (US)

Correspondence Address: MUIR PATENT CONSULTING, PLLC, 758 WALKER RD, SUITE C, GREAT FALLS, VA, 22066, US

(21) Appl. No.: 12/506,968

(22) Filed: Jul. 21, 2009

Related U.S. Application Data
(60) Provisional application No. 61/082,476, filed on Jul. 21, 2008.

(51) Int. Cl. G06K 5/00

(52) U.S. Cl. 235/380

(57) ABSTRACT

Embodiments of systems and methods are capable of selecting authorized vendors for categories of a multi-vendor gift card.

### CROSS-REFERENCE TO RELATED APPLICATION

This application claims priority under 35 U.S.C. §120 to Provisional Patent Application Ser. No. 61/082,476, the contents of which are hereby incorporated by reference in its entirety.

### BACKGROUND

1. Field

The present general inventive concept relates to a computer and/or data processing systems and methods thereof to implement electronic transactions.

2. Background

Electronic transactions for payment by individuals at a point of sale have many choices. For example, credit/debit cards may be used. However, these are only payment tools, and the relationship with the service provider/retailer is limited (e.g., network of thousands of retailers). Thus, there is no brand promotion for the service provider/retailer.

Gift cards for malls with physically co-located stores or on-line store groups may be purchased. However, the brand of the service provider/retailer is lost in the middle of dozens or hundreds of other service providers/retailers that can include competitors.

Incentive houses may provide an additional process to select a service provider/retailer, but each brand can be lost in the middle of hundreds of other brands in a large catalog that can include merchandise and travel. Further, in this situation, the service provider/retailer remains in charge (e.g., incur costs) of the gift card process that can include production, fulfillment, transaction processing, accounting, etc.

Thus, there exists a long felt need for electronic transactions that can realize service provider/retailer goals of increased traffic, decreased costs of card management, competitor differentiation; participant goals of increased choice and ease of use; and/or purchaser goals of increased visibility and control of selection that provides increased choice.

U.S. Pat. No. 5,689,100 to Carrithers et al. and U.S. Pat. No. 5,956,695 also to Carrithers et al. discuss debit card systems. Carrithers et al. '695, for example, teaches that each of a plurality of debit cards are assigned to one participant having a unique account number. A bank filter process accesses program data including data identifying the authorized unique account numbers of the participants, data identifying the authorized merchants and data indicating the balance of each participant's award account. A filter processor evaluates this data to generate validating data for the transaction when the evaluated transaction data indicates that the transaction has been initiated by an authorized merchant using the unique account number of one of the participants having a sufficient balance in the participant's corresponding award account to cover the transaction. U.S. Pat. No. 5,689,100 to Carrithers et al. and U.S. Pat. No. 5,956,695 also to Carrithers et al. are incorporated by reference herein for details of showing an example system in which the current invention may be implemented, and where appropriate, for teachings of additional or alternative details, features and/or technical background. However, neither Carrithers et al. '695 nor Carrithers et al. '100 provide guidance in which merchants are best represented in any one particular debit card.

### SUMMARY OF THE INVENTION

An object of the present general inventive concept is to address at least the above problems and/or disadvantages or to provide at least the advantages and/or utilities described hereinafter in whole or in part.

Another object of the present general inventive concept is to provide systems and methods of selecting authorized vendors for a multi-vendor gift-card in which a first sales category authorized vendor can select at least one unauthorized vendor in the first sales category.

Additional aspects and/or utilities of the general inventive concept will be set forth in part in the description that follows, and in part, will be obvious from the description, or may be learned by practice of the present general inventive concept.

### BRIEF DESCRIPTION OF THE DRAWINGS

The embodiments will be described in detail with reference to the following drawings in which like reference numerals refer to like elements wherein:

FIG. 1 is a diagram illustrating an embodiment of a system to implement a multi-vendor gift card program in accordance with the present general inventive concept;

FIG. 2 is a diagram illustrating an exemplary multi-vendor gift card;

FIG. 3 is a diagram illustrating an embodiment of a process to select vendors for a multi-vendor gift card program in accordance with the present general inventive concept;

FIG. 4 is a diagram illustrating another embodiment of a system to implement a multi-vendor gift card program in accordance with the present general inventive concept; and

FIG. 5 is a diagram illustrating an embodiment of a process to implement a multi-vendor gift card program in accordance with the present general inventive concept.

### DETAILED DESCRIPTION

Reference will now be made to exemplary embodiments according to the present general inventive concept, examples of which are illustrated in the accompanying drawings, wherein like reference numerals refer to like elements throughout. The exemplary embodiments are described below to explain the present general inventive concept by referring to the figures.

A credit card is a card that lets a consumer access funds in a credit line set aside for that user. When the purchase is made, and settlement occurs, funds are drawn from the credit line and deposited to the account of the service providers/retailers (e.g., merchant).

On the other hand, a debit card is a payment card whose funds are withdrawn directly from the cardholder's checking account. With an on-line debit card, the customer must authorize payment (e.g., enter a PIN) at the time of sale (e.g., the funds are settled through a debit network). In the case of off-line debit cards (generally with Visa or MasterCard logos) the customer signs a receipt, as would be the case in a credit card transaction. In this case, the funds are transferred after batch settlement.

Gift cards are generally provided for a single retailer (e.g., toy store chain, book store chain) or a single location (shopping mall) or a single retailer conglomerate (e.g., owner of different ownership related retailers (e.g., subsidiary)). Accordingly, funds equivalent to the face value (e.g., monetary value) of the gift card are transferred to a corresponding account before or upon activation of the gift card.

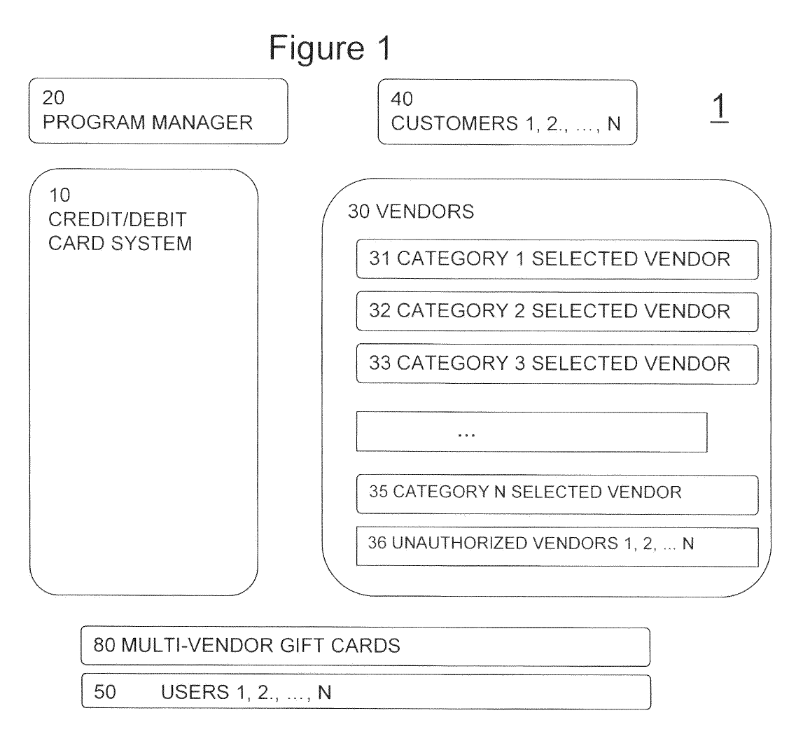

One embodiment of a system 1 according to the present general inventive concept is illustrated in FIG. 1. The system 1 can implement a multi-vendor gift card program. A multi-vendor gift card can be a debit card, a pre-paid debit card, a prepaid credit card or the like that allow the holder to access funds through an authorized vendor (e.g., service providers/retailers) for that gift card.

As shown in FIG. 1, a system 1 can include a credit/debit card system 10, vendors 30 that are coupled to use the credit/debit card system 10, a plurality of customers 40 and/or users 50 who have received a gift card for ultimate use in a debit transaction (e.g., sales transaction or purchase transaction). The system 1 can be used to implement embodiments of a multi-vendor gift card (MVGC) program and methods thereof. The system 1 can further include a program manager 20 for one or more MVGC programs and multi-vendor gift cards 80.

The system 1 is intended to permit participants (e.g., customers 40, users 50) to obtain products and/or services from authorized service providers/retailers or authorized vendors (e.g., category 1, . . . , N selected vendors 31, 32, 33, 35) who are part of an individual multi-vendor gift card program and who are part of the credit/debit card system 10, which credit/debit card network 10 also includes unauthorized service providers/retailers or unauthorized vendors (e.g., category 1, . . . , N unauthorized vendors 36), which are not part of the individual multi-vendor gift card program, but are part of the credit/debit card system 10.

An exemplary credit/debit card system 10 in the system 1 can include a credit/debit network (e.g. Visa, MasterCard, STAR, etc.), an issuing bank to implement a plurality of unique accounts and corresponding cards, which will be accepted in the credit/debit network, and a credit/debit processor to manage the account balances and approval/disapproval of individually initiated credit/debit transactions at vendors 30. U.S. Pat. No. 5,956,695, incorporated by reference, provides details of exemplary structure which may be used to implement various elements of system 1 (see, e.g., FIG. 1 of U.S. Pat. No. 5,956,695 and the corresponding description). The credit/debit processor can further manage contractual related payments (e.g., commissions) between members of the credit/debit card system 10. In the credit/debit card system 10 shown in FIG. 1, the issuing bank, the credit/debit network and the credit/debit processor can be separate entities, however, the credit/debit card system 10 can be set up as a single entity (e.g., AMEX), or various combined entities (e.g., the issuing bank and the credit/debit processor could be a single entity).

In the exemplary system 1, a plurality of different multi-vendor gift card programs can be implemented.

In one embodiment, a plurality (e.g., two or more) of categories will be selected for each multi-vendor gift card program. For example, the program manager, the customer or the like can select the categories. Exemplary categories can include department store, clothing store, restaurant, electronics, discount store, book store, specialty store, home improvement store, coffee store, music store, movie theater, toy store, movie rental store, grocery store or the like. In another example, categories can include retailer categories identified within a shopping mall, a business phone book or the like. In another embodiment, categories could include the categories defined by a prescribed merchant identifier within a credit/debit card system 10.

In another example, categories can include vendor-identified categories, which are independently identified by a selected vendor.

In another example, categories can include theme-based categories such as travel, health and wellness, home, dinner, fuel, school, music, him, her, teen, baby or electronics. In another example, categories can include theme-based categories such as location (e.g., within X miles of employer or home, corresponding to a city), holiday (e.g., Secretary's Day, Veteran's Day), beneficiary/individuals (e.g., relatives, coaches, bus drivers), or affiliation (e.g., elementary school, high school, cub scouts).

Exemplary theme based multi-vendor cards are illustrated in Table 1.

TABLE 1

| Theme | Categories | | | | |
|---|---|---|---|---|---|
| Fashion/ | General | Women's | Men's | Dept. | Sporting |
| Apparel | | | | Store | |
| Home | Furnishing | Accessories | Improvement | | |
| Enter- | Movie | Bookseller | Ticket | | |
| tainment | theater | | Box office | | |

In another example, categories can include sub-categories that can include categories identified above and/or additional criteria (e.g., location, distance between or to an identified location or combinations of categories).

In one embodiment, a multi-vendor gift card can include three or more categories, five or more categories, ten or more categories, fifteen or more categories, twenty or more categories, thirty or more categories, fifty or more categories, one hundred or more categories, two hundred or more categories, less than all categories or the like.

According to embodiments of the present general inventive concept, once a selected vendor in a category (e.g., authorized vendor for a category) is identified, that selected vendor can exclude at least one other vendor in that category (e.g., unauthorized vendor for a category). In this manner, the selected vendor can benefit by increasing traffic to its stores via the multi-vendor gift card program and prevent (or reduce) sales from the multi-vendor gift card program from going to that excluded vendor. This benefit can increase, for example, should the program manager contractually agree to distribute to users an increasing annual monetary value from the multi-vendor gift card program.

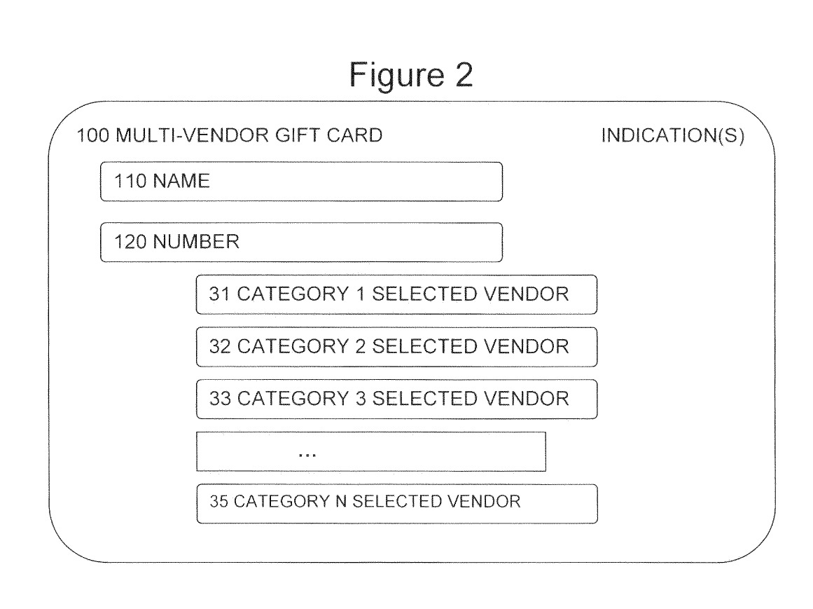

FIG. 2 is a diagram illustrating an exemplary multi-vendor gift card. As illustrated in FIG. 2, a multi-vendor gift card 100 can include a number 120 (e.g., unique account) and a plurality of authorized vendors, one for each of a plurality of categories 31, 32, 33, . . . , 35. Generally, the multi-vendor gift card 100 also includes a user name 110 and optionally an indication(s) (e.g., name/logo/trademark) of a program manager, issuing bank, paid advertiser or the like. Similarly, the plurality of authorized vendors for each of a plurality of categories 31, 32, 33, . . . , 35 could be identified by alternative indications such as logos or trademarks instead of or in addition to names. The number 120 may be a code and may be stored on the card in some format. For example, the multi-vendor gift cards can also include an embedded IC chip, bar code, a magnetic strip or other computer readable medium which stores the code. Alternatively or in addition, the card may include printed matter (e.g., scratch off) which sets forth the code. The code may be uniquely associated with an account (e.g., a funded bank account, a bank account which has funds otherwise available to it, or a loan account such as those associated with a credit card). The code may contain information and/or represent which merchants are authorized vendors and may use the card for payment of a customer's purchase. The code may take the form of a credit/debit card number in a standard format accepted by established credit/debit networks. The code may also include a personal identification number (“PIN”) or an activation code. The card may also include personalized information, such as a printed name, a denomination, a personalized message. Exemplary multi-vendor gift cards can also include known smart cards.

In one embodiment, the selected vendor in a category can exclude at least two other vendors, at least five other vendor or all identified vendors in the category. Thus, a selected book store for the multi-vendor gift card could exclude at least one other book store of its choice in a category of “book store” in one embodiment of a multi-vendor gift card program.

In one embodiment, a user is beneficially provided increased choice by the added categories or independent vendors that accept the gift card. Accordingly, identified waste in the gift card industry may be reduced. Currently, a large amount of gift cards go unused and many users receiving gift cards do not like the retailer identified.

Further, such dissatisfaction with current single service provides/retailers gift cards is evident by numerous businesses that now exist to trade or sell (e.g., for cash) activated/received gift card at Web sites such as Cardavenue.com, PlasticJungle.com and Swapagift. However, such systems to change unwanted gift cards are costly and/or cumbersome.

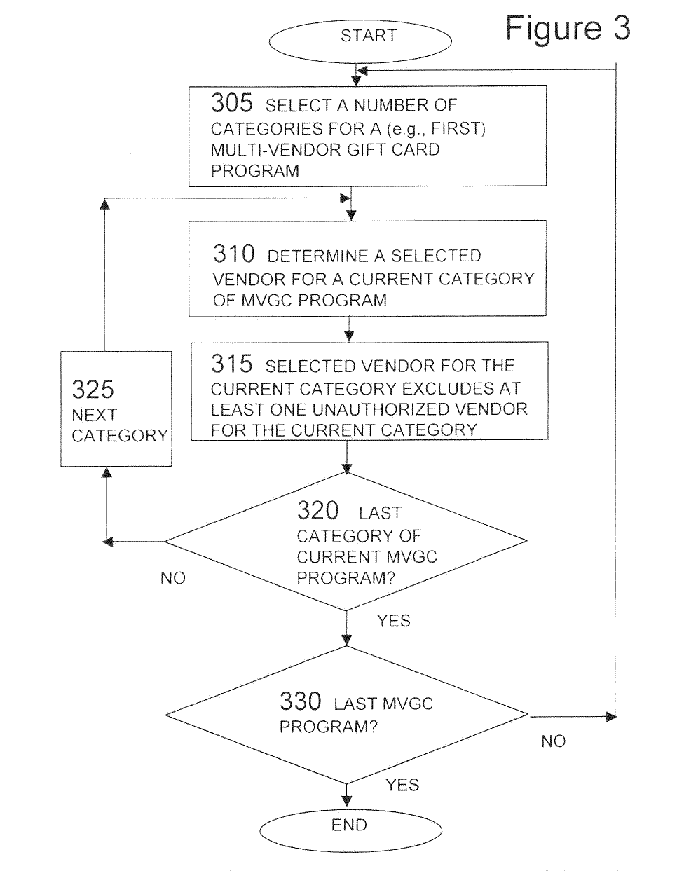

FIG. 3 is a diagram illustrating an embodiment of a process to select vendors for a multi-vendor gift card program in accordance with the present general inventive concept. As illustrated in FIG. 3, after a process begins, a number of categories can be selected for a (e.g., first) multi-vendor gift card program in operation block 305. For each category in the (e.g., first) multi-vendor gift card program, an authorized vendor for that category (e.g., a current category) can be determined in operation block 310. The authorized vendor for each category then can choose or determine at least one unauthorized vendor for the category (e.g., the current category) in operation block 315.

The determination whether additional categories for the (e.g., first) multi-vendor card program exist can be made in operation block 320. If an authorized vendor for the last category of the (e.g., first) multi-vendor gift card program is selected in operation block 320, the process can continue to optional operation block 330. Otherwise, the process can return to operation block 310 for a next category of the (e.g., first) multi-vendor card program. In one example, the process can advance to operation block 325 where the next category of the MVGC program can become a current category of the MVGC program. The determination whether additional MVGC programs (e.g., second multi-vendor card program) can be made in operation block 330. If additional MVGC programs exist, the process can return to operation block 305, otherwise, the process can be completed. Thus, in the method embodiment of FIG. 3, once a selected vendor in a category (e.g., authorized vendor for a category) is identified, in operation block 315 that authorized vendor can exclude at least one other vendor in that category (or select at least one other vendor as an unauthorized vendor for the entire card). In this case, the MVGC card will not be approved for any transaction with the excluded vendor (or selected unauthorized vendor). Alternatively, the authorized vendor can exclude at least one other vendor in its corresponding category for transactions in that corresponding category (or select at least one other vendor as an unauthorized vendor for the corresponding category). In this case, the MVGC card will not be approved for any transaction within the corresponding category with the excluded vendor (or selected unauthorized vendor).

In one embodiment, the authorized vendors of the multi-vendor gift card program can be chosen by the program manager to increase traffic to the selected combination of retailers or vendors. Combinations can be rated by various criteria. Such a limited selection of vendors can allow for new sales to be generated without reducing or cannibalizing existing sales because the new sales are provided via new sales channels (e.g. B to B sales and/or multi-vendor gift card sales). In addition, the MVGC can be an electronic card configured to use existing networks and existing settlement channels and hardware. Thus, there is no added cost or risk using the multi-vendor gift card to the selected service providers/retailers.

Customers of the program manager of a MVGC program can include businesses, individuals, and resellers. Sales channels for the program manager can include B-to-B channels, B-to-C channels and C-to-C channels.

For example, customers of the multi-retailer gift card can include industries with identified volumes in incentive/rewards programs. For example, embodiments of the multi-vendor gift card program can be used for industries where turnover, sales/customer service, and/or quality/safety procedures are important. For example, such categories could include: IT, Telecoms & Electronics, Finance & Insurance, Pharmaceutical & Healthcare, Automotive & Manufacturing, Retail & Call centers, Education, Healthcare, etc.

As used herein, an incentive award program may be any incentive plan or policy used to encourage or reward the participant, the participant's performance, the participant's use of particular vendors that sell goods and/or services, or a combination of these. Frequently, such programs are referred to as loyalty, frequency, affinity, retention, or performance improvement programs.

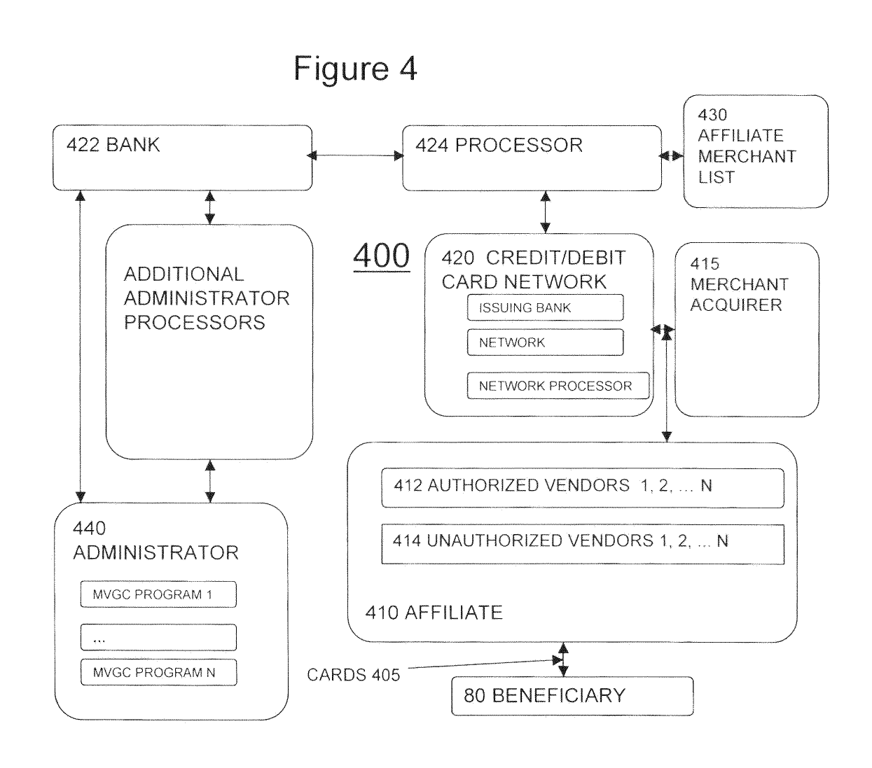

One embodiment of an electronic system 400 according to the present general inventive concept is illustrated in FIG. 4. The system 400 can implement a multi-vendor gift card program(s).

The system 400 may be implemented using or as part of a pre-existing credit/debit card network 420 (e.g., commercial network, VISA) in which affiliates 410 (e.g., service providers/retailers in the credit/debit card network) participate. The affiliates 410 can include authorized vendors 412 and unauthorized vendors 414 of individual multi-vendor gift card programs. Other service providers/retailers (e.g., merchants) that are not part of the credit/debit card network 420 are not shown.

A plurality of multi-vendor gift cards 405 for one or more multi-vendor gift card programs can be considered unique and ultimately assigned to one user. In one embodiment, one user is considered to be a plurality of associated cards (e.g., issued to members of one family). Each card 405 can have a number (e.g., unique account number) that can be printed on the card such as by raised lettering and may also be encoded on a magnetic strip, chip or the like that is part of the card. This number can identify an account corresponding to the user. The account can be the vehicle by which a transaction at an affiliate 410 can be evaluated.

One aspect of the system 400 is a processor 424 that can be independent, controlled by the system manager (e.g., administrator) or supplied by and controlled by a bank or other financial institution, the credit/debit card network 420 or the like. The processor 424 can interface (e.g., wireless/wireline) with a processor of the credit/debit card network 420 or affiliates. For example, the processor 424 may be any of a plurality of financial institutions associated with and linked to such networks 420 for administering credit/debit cards issued by the financial institution.

The processor 424 can be provided with program data for one or more MVGC programs. Thus, the processor 424 can be provided with data identifying the authorized MVGC program account numbers (e.g., unique numbers) of cards 405 issued by the financial institution or bank 422. Each account number can be assigned to one particular user and that user's card or cards 405 bears the assigned account number, which account number can corresponds to an account of the participant (e.g., set of account numbers, gift card accounts or award account). In addition, the processor 424 can access program data to identify the authorized vendors 412 and/or unauthorized vendors 414 of affiliates 410 for each MVGC program.

The affiliate identification data can be part of the program data of the system 400. For example, the affiliate identification data can be maintained in an affiliate merchant list 430 or the like. For example, each card 405 or multi-vendor gift card program can correspond to one or more affiliate merchant lists 430. Such merchant identification data may not be needed to process credit card transactions because for each credit/debit card transaction, it is assumed that all affiliates 410 that access the credit/debit card network 420 are part of the credit/debit card network 420. Further, the affiliated merchant list 430 may be configured to determine the authorized vendor for each category of vendor of the multi-vendor gift card. Alternatively, the affiliated merchant lists could be a list of unauthorized vendors (e.g., by category) in which a match can disapprove an individual MVGC transaction.

In addition, the processor 424 can access the program data to determine the balance corresponding to each MVGC account number. This balance can be controlled and maintained by the participant. In another example, the balance can be controlled and maintained by the user. In another example, the balance can be controlled and maintained by the bank 422.

As illustrated in FIG. 4, the MVGC program data may be accessible to the processor 424 via an interconnection with the issuing bank 422 (e.g., processor of the bank/administrator or the like). As a result of this interconnection, the MVGC program data may be provided to the processor 424 on a real time and/or batch basis. Optionally, it is also contemplated that an intermediary agents (e.g., processors) of the system 400 may be added that would allow the administrator to generate reports and otherwise manipulate the program data independent of the issuing bank 422 or host processor thereof and independent of interconnections to the processor 424.

A transaction (e.g., debit transaction) is initiated by an affiliate using an initiating MVGC card having an initiating account number. The initiating card may be one of the cards 405 of the system 400 or may be some other type of card, such as a credit card or debit card, which is not a part of the MVGC program that may be used with the credit card network processor 420 to access a card user's credit or the like.

In general, debit cards are very different and distinguishable from credit cards and gift cards are very different and distinguishable from debit cards. Generally, credit/debit/gift cards can be set to use monetary funds, however, corresponding indicia of funds such as points, rewards, coupons or the like may be similarly used.

In general, cards 405, credit cards and debit cards may have the same physical appearance, structure, and follow the same steps at point of purchase. Therefore, an initiating affiliate 410 may choose not to determine whether the initiating card is one of the cards 405 of the system or some other electronic card. Therefore, the debit transaction can be transparent to the initiating affiliates to the extent that the initiating affiliate does not have to distinguish between MVGC transactions using the card 405, debit transactions using the debit card, debit transactions using a gift card and transactions using a credit card or the like and can process the transactions in the same manner.

Upon initiating a MVGC transaction (e.g., sales/debit) at an affiliate 410, MVGC transaction data is provided to the credit/debit card network 420 via one of the network 420 interconnections (e.g., wireless/wireline). For example, authorized vendors 412 may initiate a MVGC transaction by using its card reader at a stand-alone point of sale (POS) terminal or an integrated POS terminal, to read the initiating card and provide transaction information that can include MVGC identification information (such as the number 120 on card 100), vendor identification and data indicating the amount of the initiating MVGC transaction via a merchant acquirer 415. In response to a MVGC transaction initiated by an affiliate using the initiating card 405 having the initiating account number, MVGC transaction data can be transmitted from the credit/debit card network 420 to the processor 424.

In one embodiment, the processor 424 is provided with MVGC program data from the issuing bank 422 or the like and is also provided with transaction data from the affiliate 410 via the credit/debit card network 420. The processor 424 can include the capability to evaluate the received transaction data (e.g., compare the transaction data to the program data). The processor can generate validation (e.g., validating data) of the initiated MVGC transaction when the evaluated MVGC transaction data indicates that the transaction has been initiated by an authorized vendor 412 using the MVGC account number of one of the users having a sufficient balance in the user's corresponding account to cover the MVGC transaction. The validating data may be in the form of a signal provided to the initiating affiliate 410 indicating that the MVGC transaction has been “APPROVED.” Conversely, the processor 424 preferably also has the ability to generate invalidation (e.g., invalidating data) in response to the initiated transaction when the evaluated transaction data indicates (i) that the initiating account number is not one of the MVGC authorized account numbers, (ii) that the initiating affiliate is not one of the authorized vendors 412, (iii) that the balance in the account corresponding to the initiating MVGC account number is insufficient to cover the amount of the initiated MVGC transaction or the like. The invalidation (e.g., invalidating data) may be in the form of a signal provided to the initiating affiliate 410 indicating that the MVGC transaction has been “DISAPPROVED.” The structure of processor 424 may be embodied in many different forms, such as a computer or server. The processor 424 may include a computer readable medium including software and/or a database and/or lookup table to implement the above. The database and/or lookup table stored in the computer readable medium may include information associating the account number with authorized (or unauthorized) vendors. Alternatively, or in addition, the database and/or lookup table stored in the computer readable medium may include information associating the account number with vendors which are unauthorized. Alternatively, the software may be stored in a separate computer readable medium than the computer readable medium in which the database and/or lookup table is stored. In this case, it may be preferable that the database and/or lookup table is stored at a location separate from processor 424.

In general, a complete MVGC transaction (e.g., debit transaction) according to the present general inventive concept can include a pre-authorization process and a force post process. In addition, a settlements/commissions process can be incorporated to automatically determine commissions etc. to participants (vendors, users, processors, banks, networks and/or participants) in the system 400.

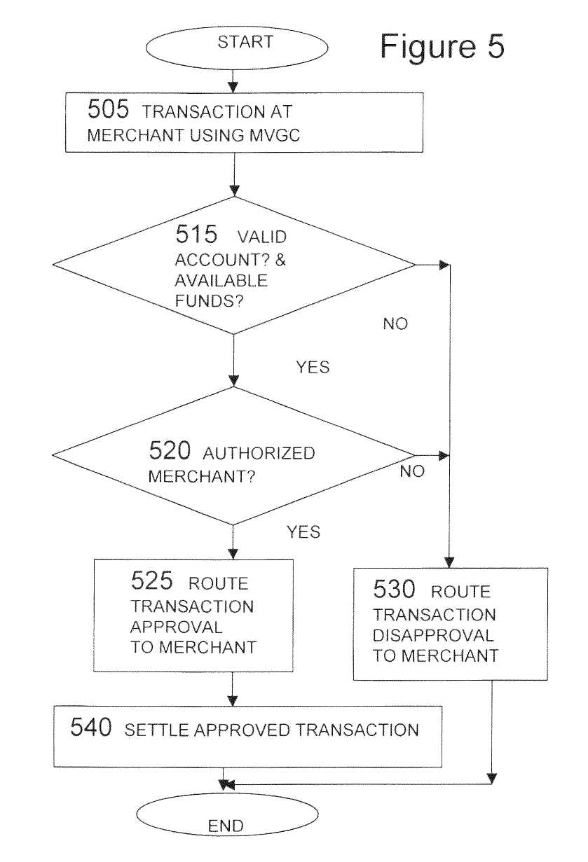

An embodiment of a method for using a multi-vendor gift card according to the present general inventive concept will now be described with respect to FIG. 5. As shown in FIG. 5, the method embodiment of FIG. 5 will be described using described system embodiments, however, the method embodiment of FIG. 5 is not intended to be so limited.

As shown in FIG. 5, after a process begins, a beneficiary can conduct a transaction (e.g., purchase) using a multi-vendor gift card (e.g., electronic card 405) at an affiliate vendor location (operation block 505).

The MVGC transaction can be evaluated to validate status of individual transaction data (multi-vendor gift card transaction data) including card validity (e.g., account number) and funds availability (operation block 510). For example, the affiliate can capture the transaction and forward the transaction data via a message to a corresponding merchant acquirer (e.g., processor). The merchant acquirer can send the transaction (e.g., through a credit card network, Discover) to a corresponding processor 424, for example based upon BIN (e.g., account number).

The MVGC transaction can then be evaluated to determine the validity of the initiating affiliate (operation block 520). For example, the processor 424 can then validate the affiliate identification code in the MVGC transaction data based upon the corresponding multi-vendor gift card (e.g., the product code in the card number). For example, up to a prescribed number of product codes (e.g., 500) can be established. Further, additional risk status checks may be performed as necessary (e.g., operation blocks 515, 520).

Thus, the processor can compare MVGC transaction data from the affiliate service providers/retailers to program data of the corresponding multi-vendor gift card program (e.g., account number, authorized vendor (e.g., in a category) and account balance).

An MVGC authorization (e.g., transaction approval/disapproval) can then be provided to the initiating affiliate (operation blocks 525, 530). For example, if the account and affiliate are valid and funds are available, the processor can send an approval authorization message to the initiating affiliate (operation block 525). Otherwise, the processor can send a disapproval authorization message to the initiating affiliate (operation block 530). For example, the processor can sent the authorization message back to the merchant acquirer through the credit card network. The merchant acquirer can transmit the authorization message to the initiating affiliate.

The approved MVGC transaction can then be settled (operation block 540). For example, the credit card network can settle the transaction to the merchant acquirer and to the processor. Further, the processor settles transaction to the issuer bank (e.g., card issuer). The administrator or funding bank preferably then transfers funds to the issuer bank.

In one embodiment, a single authorization message (or process) can implement the approval and disapproval) of the an evaluated transaction

A vendor 30 generally bears the cost of having a vendor account with a payment processing company (e.g., credit/debit network system 10), which can provide additional credibility and increased sales to the vendor. The payment processing company can provide a payment gateway that can use existing payment networks. The payment networks can include debit card networks or credit card networks or combined networks.

For example, secure payment gateway companies (e.g., processors) can conduct secure business by providing a system that passes transaction information such as card data, authorization requests, and authorization responses using encryption technology (e.g., wireline/wireless). Such encryption technology can include using the Internet (e.g., Secure Socket Layer (SSL) technology).

Alternatively, the transaction information can be controlled or sent by a payment gateway acquirer (e.g., secure server) via leased line to the credit card network where the validity of the card is checked and the availability of funds on that account is verified. An authorization code is returned via leased line to the payment gateway acquirer; the authorization is encrypted by the payment gateway acquirer and transmitted in encrypted form to the vendor (e.g., web server of the vendor), which triggers fulfillment of the order.

As described above, rather than implement their own individual or shared Secure System, many banks and bank/processor alliances can use a secure payment gateway provider to perform this task for them. However, some payment processing companies have their own secure payment gateway (e.g., for the Internet). In this case, there would be no gateway fees, only the cost of the vendor account itself.

In one embodiment, the system 1 can implement a multi-vendor gift card program managed by an administrator for a customer having users, which are selected to be part of an individual or designated MVGC gift card program. In another embodiment, the system 1 can implement an electronic multi-vendor gift card program managed by an administrator for customers being individuals purchasing multi-vendor gift cards. In one embodiment, participants can be considered a service provider/retailer (e.g., vendor).

In one embodiment, affiliates and/or additional portions of systems and method can be implemented using the Internet.

Although, embodiments disclosed using a multi-vendor gift card, additional embodiments can be configured using prepaid debit cards or limited use credit cards.

In one embodiment, MVGC and/or MVGC programs are not limited to a single credit/debit network and/or can use two or more commercial networks.

An embodiment may be achieved in a whole or in parts by a method of selecting authorized vendors for a multi-vendor gift-card that can include selecting a vendor in a first sales category to be an authorized vendor, and determining at least one vendor in the first sales category to be an unauthorized vendor, where the at least one unauthorized vendor in the first sales category is selected by the first sales category authorized vendor, and where the selecting and determining is performed for each of a plurality of categories available on the multi-vendor gift-card.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although a few embodiments of the present general inventive concept have been shown and described, it would be appreciated by those skilled in the art that changes may be made in this embodiment without departing from the principles and spirit of the general inventive concept, the scope of which is defined in the appended claims and their equivalents. As used in this disclosure, the term “preferably” is non-exclusive and means “preferably, but not limited to.” Terms in the claims should be given their broadest interpretation consistent with the general inventive concept as set forth in this description. For example, the terms “coupled” and “connect” (and derivations thereof) are used to connote both direct and indirect connections/couplings. As another example, “having” and “including”, derivatives thereof and similar transitional terms or phrases are used synonymously with “comprising” (i.e., all are considered “open ended” terms)—only the phrases “consisting of” and “consisting essentially of” should be considered as “close ended”. Claims are not intended to be interpreted under 112 sixth paragraph unless the phrase “means for” and an associated function appear in a claim and the claim fails to recite sufficient structure to perform such function.

What is claimed is:

1. A method of selecting authorized vendors for a multi-vendor gift-card, comprising:
selecting a vendor in a first sales category to be an authorized vendor; and
determining at least one vendor in the first sales category to be an unauthorized vendor, wherein the at least one unauthorized vendor in the first sales category is selected by the first sales category authorized vendor,
wherein the selecting and determining is performed for each of a plurality of categories available on the multi-vendor gift-card.

2. The method of claim 1, wherein the sales categories are determined by a category transmitted by a vendor over a credit/debit card network.

3. The method of claim 1, wherein the sales categories are determined by categories delineated by a shopping mall or a publicly distributed phone book.

4. The method of claim 1, wherein the sales categories include at least three of department store, clothing store, restaurant, electronics, discount store, book store, specialty store, home improvement store, coffee store, music store, movie theater, toy store, movie rental store, or grocery store.

5. The method of claim 1, wherein the sales categories include at least one common characteristic.

6. The method of claim 5, wherein the common characteristic categories includes at least one of location, theme, holiday, beneficiary.

7. The method of claim 6, wherein the theme includes travel, health and wellness, home, dinner, fuel, school, music or electronics.

8. The method of claim 1, wherein the multi-vendor gift card is accepted transparently at transaction ports or sales registers for a credit/debit card network.

9. A method of using a multi-vendor gift card, comprising:
initiating a sales transaction using the multi-vendor gift card at a vendor; and
directly authorizing every sales transaction by each approved vendor using a credit card network.

10. The method of claim 9, wherein every requested sales transaction by each of a plurality of multi-vendor gift cards is processed by an authorization process prior to completion of the sales transaction using the credit card network.
